(19) United States
(12) Patent Application Publication
(10) Pub. No.: US 2024/0220561 A1
(43) Pub. Date: Jul. 4, 2024

(54) INFORMATION PROCESSING DEVICE

(71) Applicant: TOYOTA JIDOSHA KABUSHIKI KAISHA, Toyota-shi (JP)

(72) Inventor: Keiko NAKANO, Kawasaki-sni, Kanagawa-ken (JP)

(73) Assignee: TOYOTA JIDOSHA KABUSHIKI KAISHA, Toyota-shi (JP)

(21) Appl. No.: 18/499,675

(22) Filed: Nov. 1, 2023

(30) Foreign Application Priority Data
Jan. 4, 2023 (JP) 2023-000281

(51) Int. Cl. G06F 16/9538; G06F 16/9535

(52) U.S. Cl. CPC G06F 16/9538; G06F 16/9535

(57) ABSTRACT

An information processing apparatus capable of communicating with a user terminal and an operator terminal includes a control unit.

The control unit executes an operation including: receiving a search request for data from a user terminal; in response to the search request, transmitting the search result to the user terminal; and electronically transmitting the additional search request and the user data to the operator terminal upon receiving an additional search request for the search result from the user terminal; receiving, from the operator terminal, a correction result for the search result; and transmitting the correction result to the user terminal.

### CROSS-REFERENCE TO RELATED APPLICATION

This application claims priority to Japanese Patent Application No. 2023-000281 filed on Jan. 4, 2023, incorporated herein by reference in its entirety.

### BACKGROUND

### 1. Technical Field

The present disclosure relates to an information processing device.

### 2. Description of Related Art

Conventionally, there has been known a navigation device that, when a voice recognition unit recognizes a voice, searches for a facility that has been recognized by voice recognition on the route in accordance with whether or not the route is being guided, changes a search range in accordance with the facility recognized by voice recognition, searches for the changed search range, and notifies a user of a search result (for example, Japanese Unexamined Patent Application Publication No. 2015-175818 (JP 2015-175818 A)).

### SUMMARY

The result of the search by the machine processing is not always a suggestion that satisfies the user's request. Therefore, there is a need to provide search results that satisfy a user's request.

It is an object of the present disclosure to provide a search result that satisfies a user's request.

An information processing device according to an embodiment of the present disclosure is able to communicate with a user terminal and an operator terminal, and includes a control unit.
The control unit executes an operation including: receiving a search request for data from the user terminal; transmitting a search result to the user terminal in accordance with the search request; when an additional search request for the search result is received from the user terminal, electronically transmitting the additional search request and user data to the operator terminal; receiving a correction result for the search result from the operator terminal; and transmitting the correction result to the user terminal.

According to the embodiment of the present disclosure, it is possible to support the provision of a search result that satisfies a user's request.

### BRIEF DESCRIPTION OF THE DRAWINGS

Features, advantages, and technical and industrial significance of exemplary embodiments will be described below with reference to the accompanying drawings, in which like signs denote like elements, and wherein:

FIG. 1 is a schematic diagram of an information processing system according to the present embodiment;

FIG. 2 is a block diagram illustrating a configuration of an information processing apparatus;

FIG. 3 is a block diagram illustrating a configuration of a user terminal;

FIG. 4 is a block diagram illustrating a configuration of an operator terminal;

FIG. 5 is a sequential diagram illustrating an operation of the information processing system; and

FIG. 6 is a diagram illustrating a display screen of the user terminal.

### DETAILED DESCRIPTION OF EMBODIMENTS

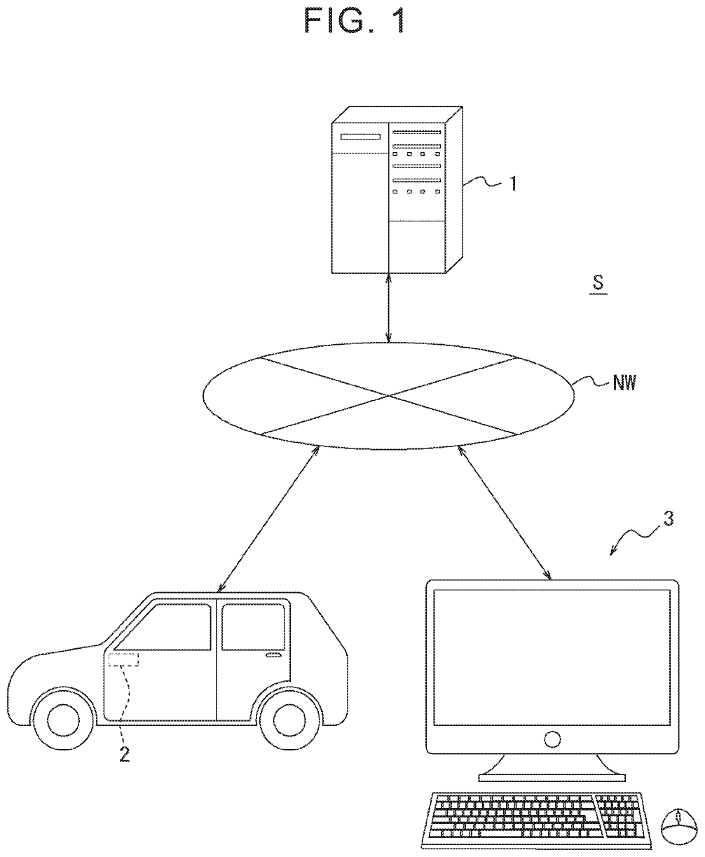

FIG. 1 is a schematic diagram of an information processing system S according to the present embodiment. The information processing system S includes an information processing device 1, a user terminal 2, and an operator terminal 3 that can communicate with each other via a network NW. The network NW includes, for example, a mobile communication network, the Internet, or a fixed communication network.

In FIG. 1, the information processing device 1, the user terminal 2, and the operator terminal 3 are illustrated one by one for convenience of explanation. However, the number of the information processing device 1, the user terminal 2, and the operator terminal 3 is not limited to this. For example, the processes executed by the information processing device 1 may be executed by a plurality of information processing devices 1 disposed in a distributed manner. The plurality of user terminals 2 may be operated by the same user. The plurality of operator terminals 3 may be operated by the same operator. The information processing device 1 may be capable of communicating with a plurality of user terminals 2 and an operator terminal 3.

The information processing device 1 may be a server that supports the provision of services by a business operator. The information processing device 1 may be installed in, for example, a facility dedicated to a business operator or a shared facility including a data center. Alternatively, the information processing device 1 may be mounted on the user terminal 2 or the operator terminal 3. The information processing device 1 may be referred to as a center server.

The user terminal 2 includes, for example, a navigation device mounted on a vehicle, or a mobile device such as a smartphone, a mobile phone, a wearable device, or a tablet. Alternatively, the user terminal 2 may be a general-purpose device such as a PC or a dedicated device. The term “PC” is an abbreviation for “personal computer”.

The operator terminal 3 is a terminal operated by an operator. There may be a plurality of operators. The operator terminal 3 includes a general-purpose device such as a PC, or a dedicated device. Alternatively, the operator terminal 3 may be a mobile device such as a smartphone, a mobile phone, a wearable device, or a tablet.

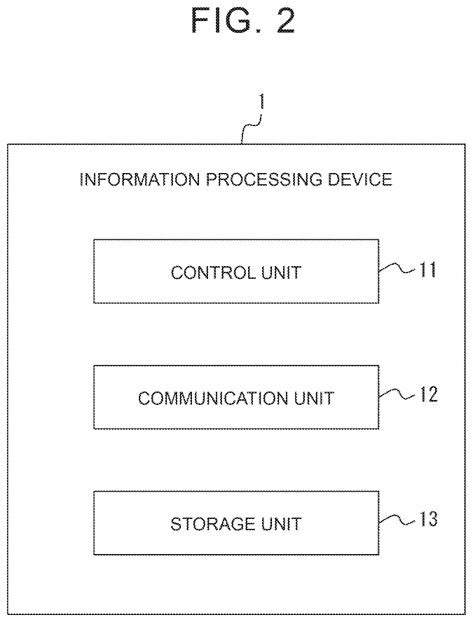

The internal configuration of the information processing device 1 will be described in detail with reference to FIG. 2.

The information processing device 1 includes the control unit 11, the communication unit 12, and a storage unit 13. The constituent components of the information processing device 1 are connected so as to be able to communicate with each other via a dedicated line, for example.

The control unit 11 includes, for example, one or more general-purpose processors including Central Processing Unit (CPU) or Micro Processing Unit (MPU). The control unit 11 may include one or more dedicated processors specialized for a specific process. The control unit 11 may include one or more dedicated circuits instead of including the processor. The dedicated circuitry may be, for example, Field-Programmable Gate Array (FPGA) or Application Specific Integrated Circuit (ASIC). The control unit 11 may include an Electronic Control Unit (ECU). The control unit 11 transmits and receives arbitrary information via the communication unit 12.

The communication unit 12 includes a communication module corresponding to one or more wired or wireless Local Area Network (LAN) standards for connecting to a network NW. The communication unit 12 may include modules corresponding to one or more mobile communication standards including Long Term Evolution (LTE), 4th generation (4G), or 5th generation (5G). The communication unit 12 may include a communication module and the like conforming to one or more short-range communication standards or specifications including Bluetooth (registered trademark), AirDrop (registered trademark), infrared data association (IrDA), ZigBee (registered trademark), FeliCa (registered trademark), or radio frequency identifier (RFID). The communication unit 12 transmits and receives information via the network NW.

The storage unit 13 includes a semiconductor memory, a magnetic memory, an optical memory, or a combination of at least two of them. However, the disclosure is not limited to this. The semiconductor memory is, for example, a random access memory (RAM) or a read-only memory (ROM). The RAM is, for example, a static random access memory (SRAM) or a dynamic random access memory (DRAM). The ROM is, for example, an electrically erasable programmable read-only memory (EEPROM). The storage unit 13 may function as, for example, a main storage device, an auxiliary storage device, or a cache memory. The storage unit 13 may store information on the result of analysis or processing by the control unit 11. The storage unit 13 may store various kinds of information and the like related to the operation or control of the information processing device 1. The storage unit 13 may store a system program, an application program, embedded software, and the like. The storage unit 13 may be provided outside the information processing device 1 and accessed from the information processing device 1.

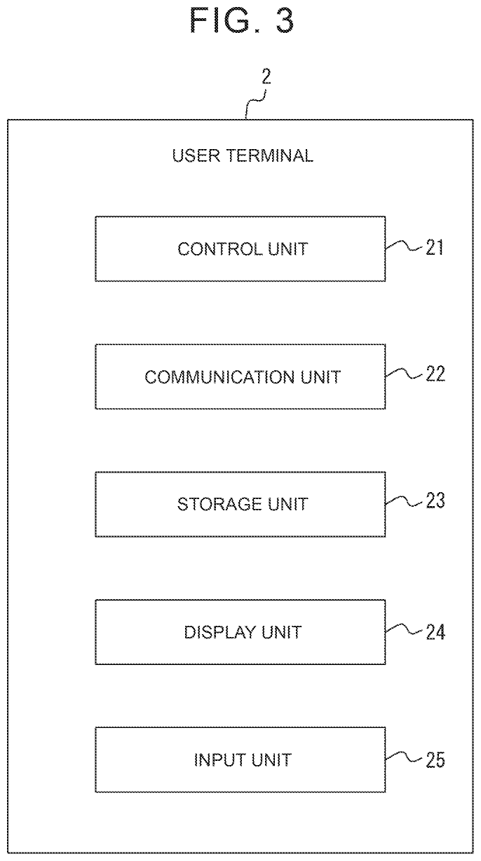

The internal configuration of the user terminal 2 will be described in detail with reference to FIG. 3.

The user terminal 2 includes a control unit 21, a communication unit 22, a storage unit 23, a display unit 24, and an input unit 25. Each component of the user terminal 2 is communicably connected to each other via, for example, a dedicated line.

The hardware configuration of the control unit 21, the communication unit 22, and the storage unit 23 of the user terminal 2 may be the same as the hardware configuration of the control unit 11, the communication unit 12, and the storage unit 13 of the information processing device 1. The description here is omitted.

The display unit 24 is, for example, a display. The display is, for example, an LCD or an organic EL display. The term “LCD” is an abbreviation for “liquid crystal display”. The term “EL” is an abbreviation for “electroluminescence”. Instead of being provided in the user terminal 2, the display unit 24 may be connected to the user terminal 2 as an external output device. As a connection method, for example, any method such as a universal serial bus (USB), a high-definition multimedia interface (HDMI) (registered trademark), or Bluetooth (registered trademark) can be used.

The input unit 25 is, for example, a physical key, a capacitive key, a pointing device, a touch screen integrally provided with a display, or a microphone. The input unit 25 receives an operation of inputting information used for the operation of the user terminal 2. Instead of being provided in the user terminal 2, the input unit 25 may be connected to the user terminal 2 as an external input device. As a connection method, for example, any method such as a universal serial bus (USB), a high-definition multimedia interface (HDMI) (registered trademark), or Bluetooth (registered trademark) can be used. The term “USB” is an abbreviation for “universal serial bus”. The term “HDMI (registered trademark)” is an abbreviation for “high-definition multimedia interface”.

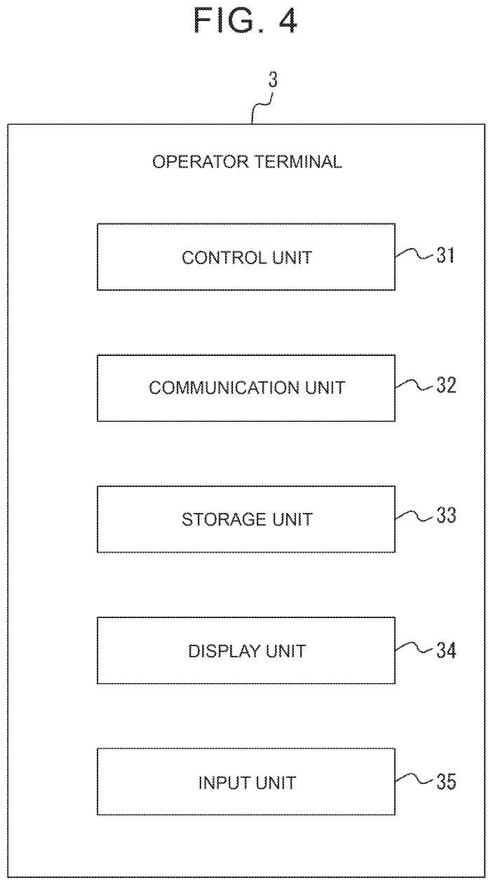

The internal configuration of the operator terminal 3 will be described in detail with reference to FIG. 4.

The operator terminal 3 includes a control unit 31, a communication unit 32, a storage unit 33, a display unit 34, and an input unit 35. Each component of the operator terminal 3 is communicably connected to each other via, for example, a dedicated line.

The hardware configuration of the control unit 31, the communication unit 32, the storage unit 33, the display unit 34, and the input unit 35 of the operator terminal 3 may be the same as the hardware configuration of the control unit 21, the communication unit 22, the storage unit 23, the display unit 24, and the input unit 25 of the user terminal 2. The description here is omitted.

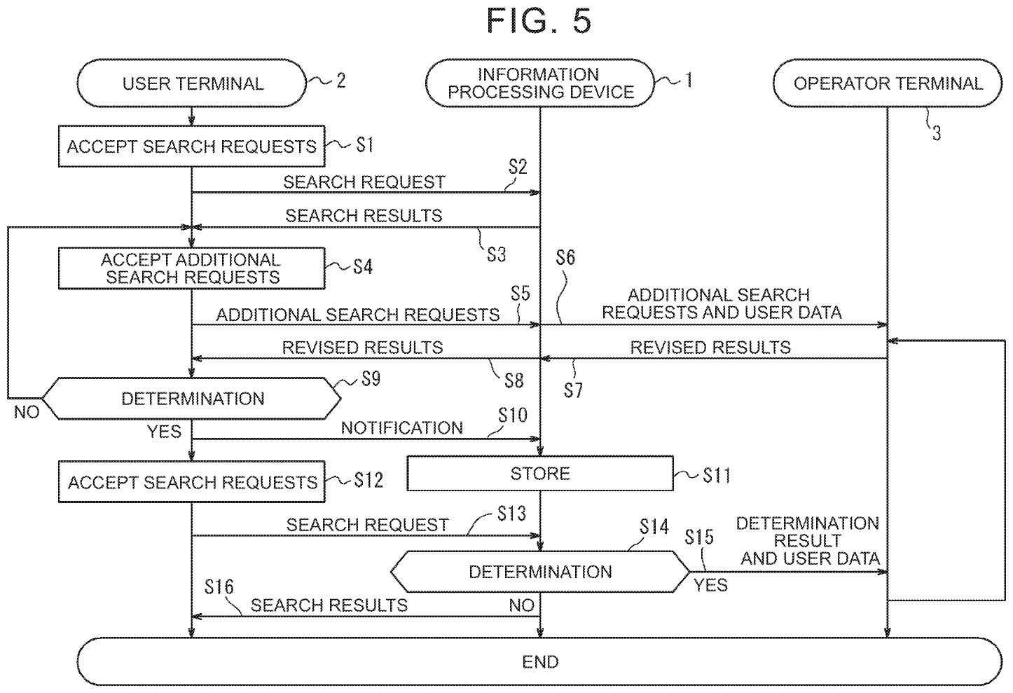

Hereinafter, a service executed by the information processing system S of the present embodiment will be described in detail with reference to a sequence diagram of FIG. 5. Here, as an example, a service for requesting an operator to search for a restaurant will be described. This service may be provided via an application installed in the user terminal 2 and the operator terminal 3. The service may be provided via a web browser of the user terminal 2 and the operator terminal 3.

In S1, the user who is searching for a restaurant in the vehicle selects or inputs a search request “search for a restaurant around the destination” via the input unit 25 of the user terminal 2 which is the navigation device. The control unit 21 receives a search request. The user may use the vehicle from now on, or may not use the vehicle. The user terminal 2 may be a mobile device such as a smartphone.

In S2, the control unit 21 of the user terminal 2 transmits a search request to the information processing device 1. The control unit 11 of the information processing device 1 receives a search request from the user terminal 2. The control unit 11 performs a search based on a search request of “search for a restaurant in the vicinity of the destination”. In S3, the control unit 11 transmits the search result to the user terminal 2.

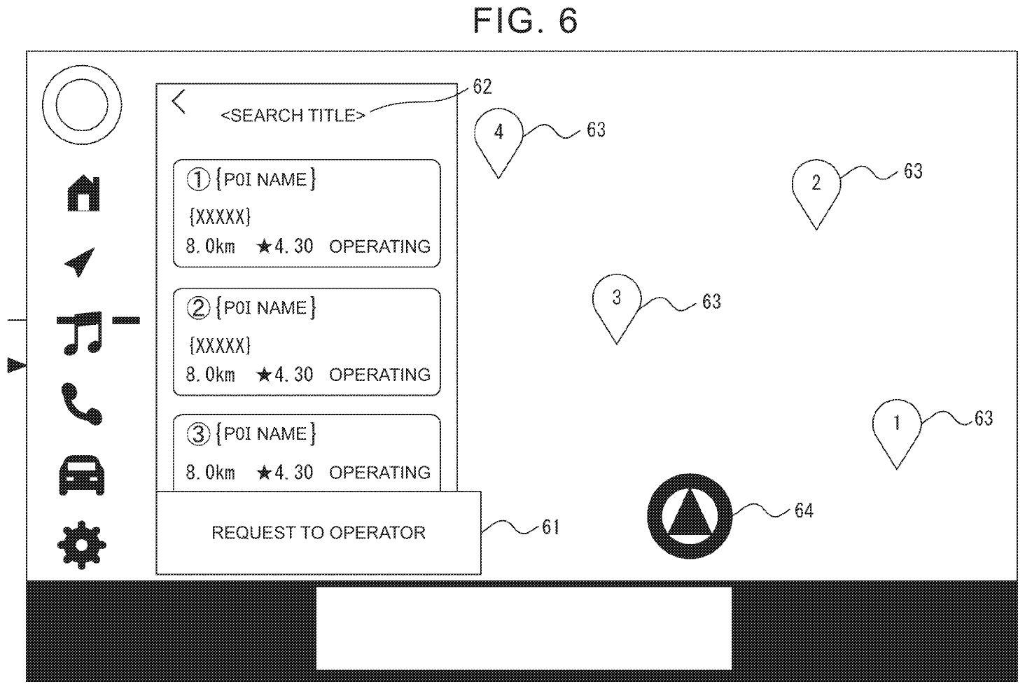

The control unit 21 of the user terminal 2 receives the search result. In S4, if the user is not satisfied with the search result by referring to the search result, the user selects or inputs an additional search request via the input unit 25. The control unit 21 receives an additional search request. As illustrated in FIG. 6, the display unit 24 of the user terminal 2 displays a “Request to Operator” button 61, a search result 62, a location 63 of a restaurant included in the search result, and a location 64 of the vehicle. Alternatively, the button may be an icon. Additional search requests may be made by selecting the “Request to Operator” button 61. Alternatively, the additional search request may be made by selecting a favorite button, such as “a cheaper store” or “friendly with children”, speech recognition by speech, or comment input. The control unit 21 transmits an additional search request to the information processing device 1.

In S5 of FIG. 5, the control unit 11 of the information processing device 1 receives an additional search request for the search result from the user terminal 2.

In S6, the control unit 11 of the information processing device 1 electronically transmits an additional search request and user data to the operator terminal 3. The user data may be stored in the storage unit 13 of the information processing device 1. The user data may be stored in the storage unit 23 of the user terminal 2. Here, an example is shown in which the user data is stored in the storage unit 13 of the information processing device 1. The user data is any information about the user, and includes, for example, at least one of the following.
User ID
Search results
Configuration information of the navigation device
Location information
Previous destination setting tendency or setting history based on user ID such as “like a fashionable restaurant”, “like a cheaper restaurant or emphasize cost performance”, or “familiar with a cafe”
Word-of-mouth information

When the control unit 31 of the operator terminal 3 receives the additional search request, the control unit 31 receives the search operation by the operator and creates a correction result for the search result based on the additional search request and the user data. The correction result can be created, for example, by replacing or recreating the search result. Specifically, the modification may be created such that restaurants that satisfy the search conditions (e.g., “kids space,” “parking lot,” or “barrier-free”) predicted from the user

ID are superior or include only such restaurants. Alternatively, the modified result may be created such that additional search requests, such as “kids space” or “parking lot”, are superior to or only include restaurants that match the restaurant's reality (e.g., information including word-of-mouth information, such as actual “kids space” or “parking lot” is enriched). As another alternative, the modified result may be created such that the consumer restaurant is excluded from the search result for an additional search request with “Italian delicious restaurant.” Further, as another alternative, a predetermined correction result may be prepared in advance in response to an additional search request. The control unit 31 transmits the correction result to the information processing device 1.

As an additional example, the control unit 31 receives an input or selection by an operator and creates an ambiguity notification indicating that the received additional search request is unclear. The uncertainty notification may be, for example, a PUSH notification such as “Why I want to search for kids' welcome restaurants around the destination.” Alternatively, the ambiguity notification may be a voice notification. The control unit 31 transmits an ambiguity notification to the information processing device 1. The control unit 11 of the information processing device 1 transmits an ambiguity notification to the user terminal 2. Upon receiving the ambiguity notification, the control unit 21 of the user terminal 2 can receive a response to the ambiguity notification by the user via the input unit 25. Responding to the unclear notification may be made, for example, by selecting or commenting “Yes” or “No” for PUSH notification, such as “Searching for Kids' Welcome Restaurant around the destination.” The control unit 21 transmits the selected or input response to the information processing device 1. The control unit 11 of the information processing device 1 receives a response from the user terminal 2 and electronically transmits the response to the operator terminal 3. The control unit 31 of the operator terminal 3 receives the response.

As an additional example, when the control unit 31 of the operator terminal 3 receives the additional search request, the operator terminal 3 notifies the information processing device 1 of the time required for creating the correction result with respect to the search result. The notification of times may be, for example, a PUSH notification such as “I will answer after 5 minutes.” The notification of the time may be performed only when the creation of the correction result takes a predetermined time. The control unit 11 of the information processing device 1 receives a notification of time from the operator terminal 3 and transmits the notification to the user terminal 2. The control unit 21 of the user terminal 2 receives the notification of the time, and displays, for example, “Answer after 5 minutes” on the display unit 24.

In S7, the control unit 11 of the information processing device 1 receives the correction result for the search result from the operator terminal 3. In S8, the control unit 11 transmits the correction to the user terminal 2.

Upon receiving the correction result, the control unit 21 of the user terminal 2 can display “Do you want to see the answer from the operator” on the display unit 24. Upon detecting that “Yes” is selected via the input unit 25, the control unit 21 displays the correction result on the display unit 24. Upon detecting that “No” is selected via the input unit 25, the control unit 21 can store the correction result in the notification list.

In S9, the control unit 21 of the user terminal 2 determines whether or not the user is satisfied with the correction. The user's satisfaction with the correction result is indicated, for example, by the user's approval of the correction result. When S9 indicates that the user is not satisfied with the correction result, the control unit 21 returns to S4 and accepts selection or input of a new additional search request by the user via the input unit 25. New additional search requests can be made, for example, by selecting a favorite button, such as “a cheaper store” or “friendly with children”, speech recognition by speech, or comment input. In S5, the control unit 11 of the information processing device 1 receives a new additional search request from the user terminal 2. In S6, the control unit 11 electronically transmits a new additional search request and user data to the operator terminal 3. When the control unit 31 of the operator terminal 3 receives a new additional search request, the control unit 31 receives a search operation by the operator and creates a new correction result based on the new additional search request and the user data. The procedure for creating the new correction result is the same as the procedure for creating the correction result for the search result. The description here is omitted. In S7, the control unit 11 receives a new modification from the operator terminal 3. In S8, the control unit 11 transmits a new modification to the user terminal 2.

When S9 indicates that the user is satisfied with the correction result, the control unit 21 of the user terminal 2 notifies the information processing device 1 of the determination result in S10. In S11, the control unit 11 of the information processing device 1 stores the user data and the correction result in the storage unit 13. As an alternative example, the control unit 11 may store the user data and the correction result in the storage unit 13 when the correction result is created by replacing the search result by a certain value or more. The control unit 11 may perform machine-learning on data stored in S11.

Thereafter (e.g., at a later date), the user who is looking for another restaurant in S12 selects or inputs a search request “look for a restaurant around the destination” via the input unit 25 of the user terminal 2. The control unit 21 of the user terminal 2 receives a search request. The control unit 21 transmits a search request to the information processing device 1. In S13, the control unit 11 of the information processing device 1 receives a search request from the user terminal 2. The control unit 11 performs a search based on the search request. The control unit 11 determines, in S14, whether or not a correction result for the search result is to be created for the search request based on the machine learning model learned by the data stored in S11. That is, the control unit 11 determines whether or not the search result is likely to be replaced. The control unit 11 determines that the correction result is to be created in accordance with the following information, for example, but is not limited thereto.
How often the user has made additional search requests in the past
A user who selects or inputs a plurality of search conditions and makes a search request tends to request an additional search request
Trends based on user profile
Trends based on search conditions and user profiles (e.g., trends based on “restaurant” and “parking lot” search conditions and user profiles for user age, etc.)
Time tolerance, such as time required to the destination (e.g., if 10 minutes or less to the destination, no additional search request is made, but if 1 hour or more to the destination, an additional search request is likely to be made)

When the determination result indicates that the correction result is to be generated by S14, the control unit 11 of the information processing device 1 electronically transmits the determination result and the user-data to the operator terminal 3 in S15. The control unit 31 of the operator terminal 3 receives the search operation by the operator on the basis of the determination result and the user data, and creates a correction result. The control unit 31 transmits the correction result to the information processing device 1. The control unit 11 of the information processing device 1 transmits the correction result to the user terminal 2.

When the determination result indicates that the correction result is not to be created in S14, the control unit 11 of the information processing device 1 transmits the search result to the user terminal 2 in S16.

In the present embodiment, a service for requesting an operator to search for a restaurant is described, but it should be noted that the service is also applicable in other electronic searches such as electronic OM (electronic instruction manual) searches or musical searches.

As described above, according to the present embodiment,
The operation of the control unit 11 of the information processing device 1 is as follows.
Receiving a data retrieval request from the user terminal 2;
In response to the search request, the search result is transmitted to the user terminal 2.
When an additional search request for the search result is received from the user terminal 2, the additional search request and the user data are electronically transmitted to the operator terminal 3.
Receiving a correction result for the search result from the operator terminal 3;
The method includes transmitting a correction result to the user terminal 2.
With this configuration, the information processing device 1 can support the provision of the correction result satisfying the user's request when the search result by the machine processing cannot satisfy the user's request. Further, in conventional services, when making additional search requests to an operator, the user may be required to call the operator directly. However, users tend to hesitate to make a call. Therefore, with this configuration, the information processing device 1 can support the operator to make an additional search request in a manner that does not rely on a user-originated telephone.

Further, according to the present embodiment, the operation of the control unit 11 is as follows.
Storing the user data and the correction result in the storage unit 13,
Machine learning the stored data,
If the retrieval request of data is received from the user terminal 2, based on the machine learning model learned with the stored data, it is judged whether the correction result to search results will be created about a retrieval request,
When the result of the determination indicates that the correction result is to be generated, the method includes electronically transmitting the result of the determination and the user data to the operator terminal 3.
With this configuration, the information processing device 1 can support the operator terminal 3 to receive a search operation by an operator before an additional search request is made, and to create a correction result in advance.

Further, according to the present embodiment, the operation of the control unit 11 is as follows.
When an ambiguity notification is received from the operator terminal 3 indicating that the additional search request is ambiguous, an ambiguity notification is transmitted to the user terminal 2.
Receiving a response to the ambiguity notification from the user terminal 2 includes electronically transmitting the response to the operator terminal 3.
With this configuration, the information processing device 1 can support clarification of an additional search request between the operator and the user.

In addition, according to the present embodiment, the operation of the control unit 11 includes notifying the user terminal 2 of the time when the operator terminal 3 receives the notification of the time required to create the correction result. With this configuration, the information processing device 1 enables the user to confirm the time required for creating the correction result.

Further, according to the present embodiment, the operation of the control unit 11 includes, when a new additional search request indicating that the user cannot satisfy the correction result is received from the user terminal 2, transmitting the new additional search request and the user data to the operator terminal 3. With this configuration, the information processing device 1 can support providing a new correction result satisfying the user's request even if the correction result does not satisfy the user's request.

Although the present disclosure has been described above based on the drawings and the embodiment, it should be noted that those skilled in the art may make various modifications and alterations thereto based on the present disclosure. Other changes may be made without departing from the scope of the present disclosure. For example, the functions included in each means or step can be rearranged so as not to be logically inconsistent, and a plurality of means or steps can be combined into one or divided.

For example, in the above embodiment, a program that executes all or part of the functions or processes of the information processing device 1 can be recorded in a computer-readable recording medium. The computer-readable recording medium includes a non-transitory computer-readable medium such as a magnetic recording device, an optical disc, a magneto-optical recording medium, or a semiconductor memory. Distribution of the program is performed, for example, by selling, transferring, or lending a portable recording medium such as a Digital Versatile Disc (DVD) or a Compact Disc Read Only Memory

(CD-ROM) in which the program is recorded. Further, the distribution of the program may be performed by storing the program in a storage of a server and transmitting the program from the server to another computer. Further, the program may be provided as a program product. The present disclosure can also be realized as a program that can be executed by a processor.

The computer temporarily stores the program recorded in the portable recording medium or the program transferred from the server in the main storage device, for example. The computer then causes the processor to read the program stored in the main storage device, and causes the processor to execute processes in accordance with the read program. The computer may read the program directly from the portable recording medium and execute processes in accordance with the program. The computer may execute the processes in accordance with the received program each time the program is transferred from the server to the computer. The processes may be executed by a so-called ASP service that realizes the function only by execution instruction and result acquisition without transferring the program from the server to the computer. The term “ASP” is an abbreviation for “application service provider”. The program includes information that is used for processing by electronic computers and equivalent to a program. For example, data that is not a direct command to a computer but has the property of defining the process of the computer corresponds to the “data equivalent to a program”.

What is claimed is:

1. An information processing device that is able to communicate with a user terminal and an operator terminal, the information processing device comprising a control unit, wherein the control unit executes operations including:
receiving a search request for data from the user terminal;
transmitting a search result to the user terminal in accordance with the search request;
when an additional search request for the search result is received from the user terminal, electronically transmitting the additional search request and user data to the operator terminal;
receiving a correction result for the search result from the operator terminal; and
transmitting the correction result to the user terminal.

2. The information processing device according to claim 1, further comprising a storage unit, wherein the operations include:
storing the user data and the correction result in the storage unit;
machine learning stored data;
when the search request for the data is received from the user terminal, determines whether to create a correction result for the search result, about the search request, based on a machine learning model learned using the stored data; and
when a result of determination indicates that the correction result needs to be created, electronically transmitting the result of the determination and the user data to the operator terminal.

3. The information processing device according to claim 1, wherein the operations include:
when an ambiguity notification indicating that the additional search request is ambiguous is received from the operator terminal, transmitting the ambiguity notification to the user terminal; and
when a response to the ambiguity notification is received from the user terminal, electronically transmitting the response to the operator terminal.

4. The information processing device according to claim 1, wherein the operations include, when a notification of a time required for creating the correction result is received from the operator terminal, notifying the user terminal of the time.

5. The information processing device according to claim 1, wherein the operations include, when a new additional search request indicating that a user is not satisfied with the correction result is received from the user terminal, transmitting the new additional search request and the user data to the operator terminal.
